(19) United States
(12) Patent Application Publication
(10) Pub. No.: US 2026/0260211 A1
(43) Pub. Date: Sep. 3, 2026

(54) SERVICE PROVISION DEVICE, SERVICE PROVISION SYSTEM, SERVICE PROVISION METHOD, AND NON-TRANSITORY COMPUTER-READABLE MEDIUM

(71) Applicant: NEC Corporation, Tokyo (JP)

(72) Inventors: Yaeko YONEZAWA, Tokyo (JP); Syunsuke YAMAMOTO, Tokyo (JP); Yuji TAHARA, Tokyo (JP); Soma SHIRAISHI, Tokyo (JP); Takami SATO, Tokyo (JP); Tomokazu KANEKO, Tokyo (JP); Ryosuke SAKAI, Tokyo (JP); Naohiro HAYASHI, Tokyo (JP); Azusa NAGASAWA, Tokyo (JP)

(73) Assignee: NEC Corporation, Tokyo (JP)

(21) Appl. No.: 19/164,781

(22) PCT Filed: Mar. 28, 2023
(86) PCT No.: PCT/JP2023/012527

§ 371 Date: Sep. 12, 2025

(51) Int. Cl. G06Q 10/087

(52) U.S. Cl. CPC G06Q 10/08726

(57) ABSTRACT

A service provision device (100) according to the present disclosure manages acceptance of orders for first and second delivery services having different burdens on store employees. The service provision device (100) comprises: an acquisition unit (101) that acquires customer state information indicating the states of customers in a store; a congestion estimation unit (102) that estimates the congestion state of the store on the basis of the customer state information; a determination unit (103) that determines, on the basis of the congestion state, first and second acceptable order numbers indicating the numbers of acceptable orders for the first and second delivery services; and an order acceptance unit (104) that accepts orders for the first and second delivery services on the basis of the first and second acceptable order numbers.

### TECHNICAL FIELD

The present disclosure relates to a service provision device, a service provision system, a service provision method, and a non-transitory computer-readable medium.

### BACKGROUND ART

In recent years, an online shopping service capable of purchasing a product in a store by electronic commerce (EC) using the Internet has been known. A user of the online shopping service accesses a predetermined website, for example, by using a terminal device such as a personal computer (PC) or a smartphone and orders a desired product. In addition, the user designates a delivery destination of the product. This makes it possible for the user to purchase and receive the desired product, while staying at home or the like, for example.

In a store that provides such a service, it is necessary to perform a plurality of works, after reception of an order to completion of product delivery. Necessary works include, for example, picking (collecting) a product, checkout a product, packing (boxing) a product, and delivery of a product. Such a service has at least two forms to be described below, according to a type of a person in charge of work who performs these works.

The first form is a form in which an employee of a store that receives an order performs picking, checkout, and packing of a product and a person other than the store employee delivers the product. The person other than the store employee is a person specialized in delivery, for example, a delivery business operator or the like. In the service of such a form, the store employee performs the works before the delivery, and the delivery business operator or the like only delivers the product. In the present disclosure, the service of such a form will be described as a “first delivery service”.

The second form is a form in which a person other than the store employee performs all of picking, checkout, packing, and delivery of a product. Here, the person other than the store employee is, for example, a shopping agent (hereinafter, referred to as an “agent”) who performs shopping at the store instead of an orderer. In the service of such a form, the agent or the like performs all of the works from picking to delivery of the product. In the present disclosure, the service of such a form will be described as a “second delivery service”.

As a technique related to the second delivery service described above, PTL 1 discloses an agent mediating device that mediates a requester who wishes to deliver an ordered product and a plurality of agents who delivers the ordered product to a designated place. The agent mediating device disclosed in PTL 1 gives a reward to the agent based on the delivery completion of the ordered product by the agent.

### CITATION LIST

### Patent Literature

### PTL 1: JP 2020-052598 A

### SUMMARY OF INVENTION

### Technical Problem

For example, it is assumed that the two forms of delivery services be provided in a store such as a supermarket. In a case where an orderer uses a first delivery service, a store employee picks, checks out, and packs a product in the store. In addition, a delivery business operator delivers the packed product. On the other hand, in a case where the orderer uses a second delivery service, an agent picks, checks out, packs the product in the store, and then, delivers the product.

In a case where an order for the first delivery service is received from the orderer, the store employee needs to perform picking, checkout, and packing of the product, as a response to the order, while performing a work such as checkout processing in the store or a response to an inquiry from a customer. Therefore, in a case where the first delivery service is used, a burden of the store employee applied from the reception of the order to the delivery of the product is larger than that in a case where the second delivery service is used. Therefore, since manpower for performing the work such as picking is insufficient in a case where the store is congested or the like, it is necessary to limit order reception of online shopping.

On the other hand, in a case where the second delivery service is used, since the agent performs picking, checkout, and packing of the product, the burden of the store employee is relatively small. Nevertheless, in a case where the order reception of the online shopping is uniformly limited in a case where the store is congested, there is a possibility of losing a product sales opportunity. The technique disclosed in PTL 1 does not sufficiently consider such a problem.

An object of the present disclosure is to provide a service provision device, a service provision system, a service provision method, and a non-transitory computer-readable medium that can appropriately manage reception of an order for a plurality of delivery services having different burdens of an employee in a store.

### Solution to Problem

A service provision device according to the present disclosure is a service provision device that manages reception of an order for first and second delivery services having different burdens of an employee in a store and includes

acquisition means for acquiring customer status information indicating a status of a customer in the store,

congestion estimation means for estimating a congestion status of the store, based on the customer status information,

determination means for determining each of first and second order receivable numbers indicating order receivable numbers for the first and second delivery services, based on the congestion status, and

order reception means for receiving the order for each of the first and second delivery services, based on the first and second order receivable numbers.

A service provision system according to the present disclosure is a service provision system that manages reception of an order for first and second delivery services having different burdens of an employee in a store and includes

a sensor that detects customer status information indicating a status of a customer in the store and a service provision device,

in which the service provision device includes

acquisition means for acquiring the customer status information detected by using the sensor,

congestion estimation means for estimating a congestion status of the store, based on the customer status information,

determination means for determining each of first and second order receivable numbers indicating order receivable numbers for the first and second delivery services, based on the congestion status, and

order reception means for receiving the order for each of the first and second delivery services, based on the first and second order receivable numbers.

A service provision method according to the present disclosure is a service provision method that manages reception of an order for first and second delivery services having different burdens of an employee in a store and includes

acquiring customer status information indicating a status of a customer in the store,

estimating a congestion status of the store, based on the customer status information,

determining each of first and second order receivable numbers indicating order receivable numbers for the first and second delivery services, based on the congestion status, and

receiving the order for each of the first and second delivery services, based on the first and second order receivable numbers.

A non-transitory computer-readable medium according to the present disclosure is a non-transitory computer-readable medium storing a program for causing a computer of a service provision device that manages reception of an order for first and second delivery services having different burdens of an employee in a store, and

the program causes the computer to execute

acquisition processing for acquiring customer status information indicating a status of a customer in the store,

congestion estimation processing for estimating a congestion status of the store, based on the customer status information,

determination processing for determining each of first and second order receivable numbers indicating order receivable numbers for the first and second delivery services, based on the congestion status, and

order reception processing for receiving the order for each of the first and second delivery services, based on the first and second order receivable numbers.

### Advantageous Effects of Invention

According to the present disclosure, it is possible to provide a service provision device, a service provision system, a service provision method, and a non-transitory computer-readable medium that can appropriately manage reception of an order for a plurality of delivery services having different burdens of an employee in a store.

### BRIEF DESCRIPTION OF DRAWINGS

FIG. 1 is a block diagram illustrating a configuration of a service provision device according to a first example embodiment.

FIG. 2 is a flowchart illustrating processing executed by the service provision device according to the first example embodiment.

FIG. 3 is a diagram illustrating a configuration of a service provision system according to a second example embodiment.

FIG. 4 is a diagram illustrating a person in charge of each work included in first and second delivery services according to the second example embodiment.

FIG. 5 is a block diagram illustrating a configuration of a store terminal according to the second example embodiment.

FIG. 6 is a block diagram illustrating a configuration of a service provision device according to the second example embodiment.

FIG. 7 is a delivery service selection screen for receiving selection of a delivery service used by an orderer, among the first and second delivery services according to the second example embodiment.

FIG. 8 is a store selection screen for receiving selection of a store used by the orderer, from among a plurality of stores that provides the first and second delivery services according to the second example embodiment.

FIG. 9 is a flowchart illustrating a flow of processing until the service provision device according to the second example embodiment receives an order.

FIG. 10 is a flowchart illustrating a flow of processing after the service provision device according to the second example embodiment has received the order.

FIG. 11 is a block diagram illustrating a hardware configuration of a computer that achieves the service provision device or the like.

### EXAMPLE EMBODIMENT

Hereinafter, example embodiments of the present disclosure will be described in detail with reference to the drawings. In the drawings, the same or related elements are denoted by the same reference signs. For clarity of description, redundant description will be omitted as necessary.

### First Example Embodiment

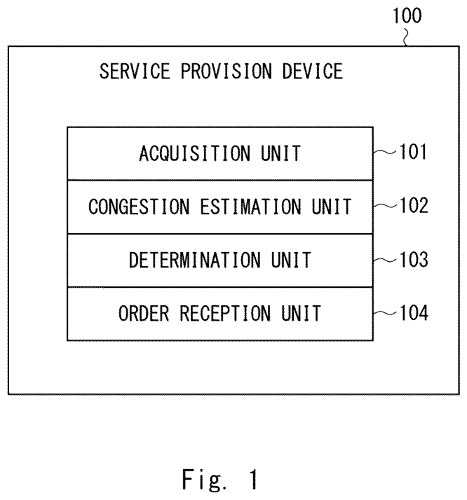

First, a first example embodiment will be described. FIG. 1 is a block diagram illustrating a configuration of a service provision device 100 according to the present example embodiment.

The service provision device 100 manages reception of orders for first and second delivery services having different burdens of an employee in a store. The service provision device 100 includes an acquisition unit 101, a congestion estimation unit 102, a determination unit 103, and an order reception unit 104.

The acquisition unit 101 acquires customer status information indicating a status of a customer in a store. The congestion estimation unit 102 estimates a congestion status of the store, based on the customer status information acquired by the acquisition unit 101. The determination unit 103 determines first and second order receivable numbers indicating receivable numbers of the orders for the first and second delivery services, based on the congestion status estimated by the congestion estimation unit 102. The order reception unit 104 receives the order for each of the first and second delivery services, based on the first and second order receivable numbers determined by the determination unit 103.

The service provision device 100 includes a processor, a memory, and a storage device as configurations not illustrated. The storage device stores a computer program on which processing according to the present example embodiment is implemented. The processor causes the computer program to be read from the storage device into the memory, and is capable of executing the computer program. As a result, the processor achieves functions of the acquisition unit 101, the congestion estimation unit 102, the determination unit 103, and the order reception unit 104.

Alternatively, each of the acquisition unit 101, the congestion estimation unit 102, the determination unit 103, and the order reception unit 104 may be achieved by dedicated hardware. Some or all of the components of each apparatus may be achieved by a general-purpose or dedicated circuitry, a processor, or a combination thereof. Those components may be configured by a single chip, or may be configured by a plurality of chips connected via a bus. Some or all of the components of each apparatus may be achieved by a combination of the above circuitry or the like and a program.

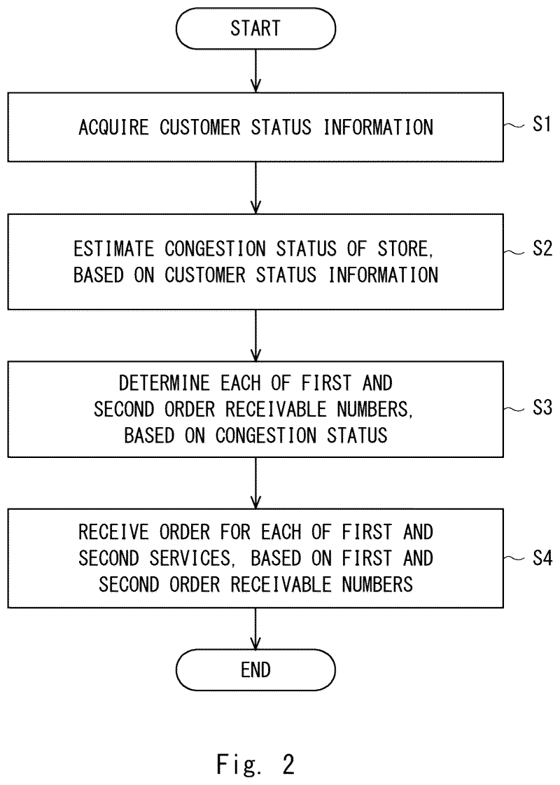

Subsequently, processing executed by the service provision device 100 will be described with reference to FIG. 2. FIG. 2 is a flowchart illustrating the processing executed by the service provision device 100.

First, the acquisition unit 101 acquires the customer status information indicating the status of the customer in the store (S1). Next, the congestion estimation unit 102 estimates the congestion status of the store, based on the customer status information acquired by the acquisition unit 101 (S2). Subsequently, the determination unit 103 determines each of the first and second order receivable numbers indicating the receivable numbers of the orders for the first and second delivery services, based on the congestion status estimated by the congestion estimation unit 102 (S3). Then, the order reception unit 104 receives the order for each of the first and second delivery services, based on the first and second order receivable numbers determined by the determination unit 103 (S4).

With such a configuration, according to the service provision device 100 according to the present example embodiment, it is possible to appropriately manage the reception of the orders for the plurality of delivery services having the different burdens of the employee in the store.

### Second Example Embodiment

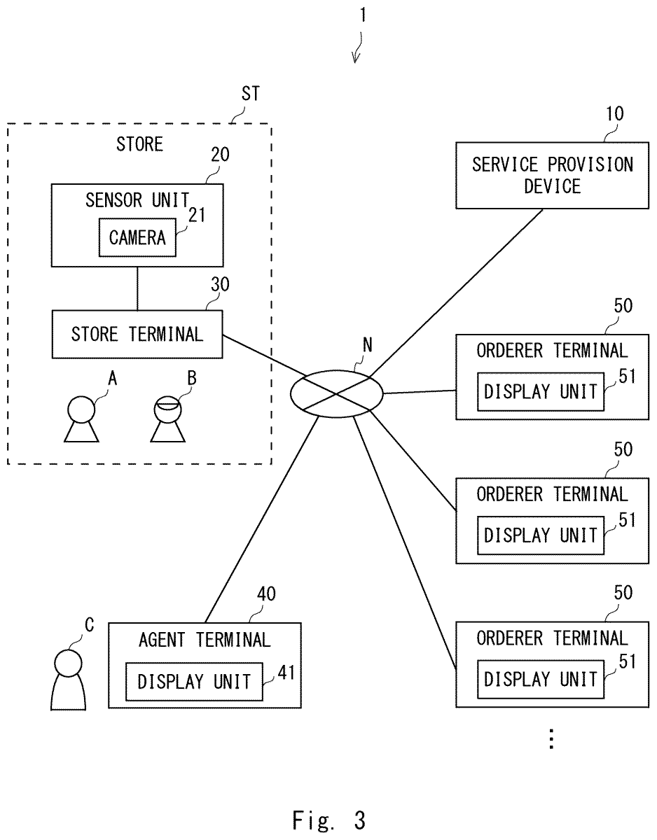

Subsequently, a second example embodiment will be described. The second example embodiment is a specific example of the first example embodiment described above. FIG. 3 is a diagram illustrating a configuration of a service provision system 1 according to the present example embodiment.

### Service Provision System 1

The service provision system 1 includes a sensor unit 20 and a store terminal 30 provided in a store ST, an agent terminal 40, a service provision device 10, and a plurality of orderer terminals 50. Each of the store terminal 30, the agent terminal 40, the service provision device 10, and the plurality of orderer terminals 50 is connected via a network N. The network N is a wired or wireless communication line. The network N may be configured using, for example, a mobile communication network such as 3G, 4G, or 5G, the Internet, a public telephone network, a satellite communication network, or the like. The numbers of the sensor units 20, the store terminals 30, the agent terminals 40, the service provision devices 10, and the orderer terminals 50 are not limited to those illustrated.

The service provision system 1 is a system that manages reception of an order for a plurality of delivery services having different burdens of an employee in the store ST. The service provision system 1 may be used in a store that provides the plurality of delivery services having the different burdens of the employee. The service provision system 1 may be used, for example, by a retailer such as a supermarket, a convenience store, or a department store. The service provision system 1 may be used, for example, in an eating place such as a restaurant or a bar. Since these are examples, the service provision system 1 may be used in various stores. The service provision system 1 provides an online shopping service including the delivery service to a user who uses the service provision system 1.

In the store ST, an employee A who works in the store ST is arranged. In addition, in the store ST, a delivery person B who delivers an ordered product is arranged. The delivery person B may be a person who belongs to a business operator different from the store ST. The delivery person B is, for example, a delivery business operator who is specialized in delivery of products. The delivery person B may be a person registered, in advance, in a delivery agent service that serves as an agent only for delivery of a product. The delivery person B may be a person in charge of only delivery and the employee of the store ST. The delivery person B does not need to be resident in the store ST. Although the one employee A and the one delivery person B are illustrated in the drawing, two or more employees A and two or more delivery persons B may be arranged.

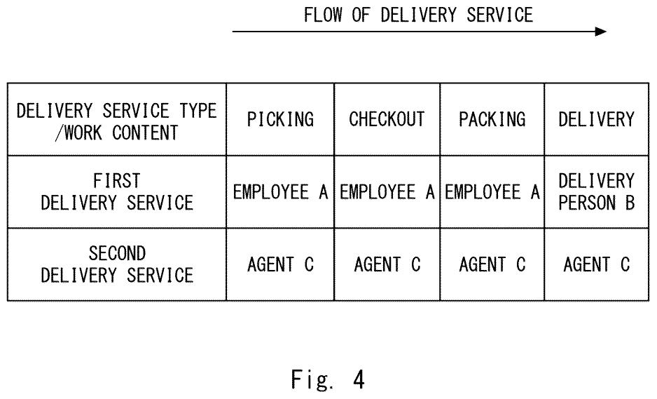

In the store ST, first and second delivery services having different burdens of the employee A are provided to the user of the service provision system 1, by using the store terminal 30. Here, with reference to FIGS. 3 and 4 together, works included in the first and second delivery services will be described. FIG. 4 is a diagram illustrating a person in charge of each work included in the first and second delivery services. In the present example embodiment, it is assumed that the first delivery service have a larger burden of the employee A than the second delivery service.

### First Delivery Service

The first delivery service is a delivery service in a form in which an employee of a store that receives an order performs picking, checkout, and packing of a product and a person other than the store employee delivers the product. As illustrated in FIG. 4, in the first delivery service according to the present example embodiment, the employee A of the store performs the work before the delivery of the product, and the delivery person B only delivers the product.

Specifically, in a case where the store terminal 30 receives an order for the first delivery service, the employee A confirms information regarding an ordered product, and picks, checks out, and packs the product. As a result, the ordered product can be delivered. The employee A passes the product in the deliverable state to the delivery person B. The employee A may pass the product to the delivery person B, by moving the product that can be delivered to a predetermined place where the product is delivered. The delivery person B receives the product from the employee A and delivers the product to a delivery destination of the product. As a result, an orderer can receive the product ordered by oneself.

### Second Delivery Service

The second delivery service is a delivery service in a form in which a person other than the store employee performs all of picking, checkout, packing, and delivery of a product. As illustrated in FIG. 4, in the second delivery service according to the present example embodiment, an agent C picks, checks out, packs, and delivers the product. The agent C may be a person who belongs to a business operator different from the store ST, similarly to the delivery person B. The agent C does not need to be resident in the store ST. The agent C may be, for example, a person registered in advance in a shopping agent service for performing shopping of the orderer on behalf of the orderer, or the like. Although only one agent C is illustrated in the drawing, the plurality of agents C may exist.

Alternatively, the agent C may be a person who belongs to a business operator cooperating with the store ST. The business operator cooperating with the store ST is, for example, a business operator having a dark store (dark store) which is a retail store dedicated to an online shopping service or the like. Although products to be sold to customers are displayed in the dark store, the dark store is used as a delivery base of products, not a store where customers visit to purchase products. In a case where a product is ordered, an employee of the dark store picks, checks out, and packs the product in the dark store. The employee of the dark store delivers the product.

By cooperating with such a dark store, the store ST can use the employee of the dark store as the agent C. As a result, the service provision system 1 can be efficiently operated.

As illustrated in FIG. 4, in the second delivery service, the agent C performs all of works from picking to delivery of the product. Specifically, in a case where the agent terminal 40 receives an order for the second delivery service, the agent C picks, checks out, packs, and delivers the ordered product. As a result, the orderer can receive the product ordered by oneself.

Since the work illustrated in FIG. 4 is an example, work content may be appropriately changed. For example, in addition to the work illustrated in the drawing, the employee A, the delivery person B, and the agent C may perform other works. For example, a part of the work of the employee A may be performed by a person other than the employee A, and the work of the delivery person B may be performed by the employee A. Alternatively, a part of the work of the agent C may be performed by a person other than the agent C. However, here, it is assumed that the first delivery service has a larger burden of the employee A than the second delivery service. For example, the checkout work in the first and second delivery services may be appropriately omitted, according to the operation in the store ST.

### Orderer Terminal 50

Returning to FIG. 3, the description of the configuration of the service provision system 1 is continued. Each of the plurality of orderer terminals 50 is a terminal device used by the orderer who uses the service provision system 1. The orderer terminal 50 is, for example, a smartphone, a mobile phone terminal, a tablet terminal, a PC, or the like.

The orderer uses the online shopping service provided by the service provision device 10, by using the orderer terminal 50. Specifically, the orderer accesses a predetermined website by using the orderer terminal 50, to use the online shopping service. The orderer terminal 50 executes order processing on the service provision device 10, via the website. The orderer terminal 50 may access the service provision device 10 via a predetermined application.

The orderer terminal 50 includes a display unit 51 that displays information regarding online shopping. The display unit 51 displays, for example, information regarding a product. The orderer terminal 50 receives an input of the orderer, via an input unit (not illustrated). The input unit is, for example, a keyboard or a mouse. The input unit may have a function of a touch panel. The orderer terminal 50 receives selection of a store or a delivery service from the orderer. In addition, the orderer terminal 50 receives an input of order information including order content, a delivery date and time, a product, orderer information, or the like from the orderer. The orderer information indicates information regarding an orderer, such as a delivery destination of a product or a contact address of the orderer, for example. The orderer terminal 50 transmits an order request including the order information to the service provision device 10. As a result, the orderer terminal 50 executes the order processing.

### Agent Terminal 40

The agent terminal 40 is a terminal device used by the agent C. The agent terminal 40 is, for example, a smartphone, a mobile phone terminal, a tablet terminal, a PC, or the like, similarly to the orderer terminal 50. The agent terminal 40 includes a display unit 41 that displays information regarding an order for the second delivery service.

The agent terminal 40 receives the order for the second delivery service from the service provision device 10. Specifically, the agent terminal 40 receives the order for the second delivery service, by receiving the order information including the order content, the delivery date and time, the product, the orderer information, or the like regarding the second delivery service from the service provision device 10. The agent terminal 40 displays content of the order information on the display unit 41. The agent C grasps the content of the ordered product by visually recognizing the content on the display unit 41 and performs works from picking to delivery of the product.

### Sensor Unit 20

The sensor unit 20 is a detection device that detects customer status information including a status of a customer in the store ST. The customer status information is information that may affect reception of the order for the first and second delivery services. The customer status information may be, for example, information indicating a congestion status in the store ST. The customer status information may include, for example, information regarding the number of customers in the store ST, a stay time of the customer in the store ST, an operation status of a settlement device in the store ST, or the number of customers waiting for checkout in the store ST. The customer status information is not limited to this, and the customer status information may include various types of information regarding the customer.

For example, in a case where the number of customers in the store ST is equal to or more than a predetermined number, the number of employees coping with the reception the order for the first delivery service becomes insufficient. Therefore, it is necessary to limit the reception of the order for the first delivery service. In addition, in a case where the number of customers further increases, it is necessary to limit the reception of the order for the second delivery service. In this way, the status of the customer in the store ST may affect the reception of the order for the first and second delivery services.

The sensor unit 20 may be used as a detection device that detects employee status information indicating a status of the employee in the store ST. The employee status information is information that may affect the reception of the order for the first and second delivery services. The employee status information may include, for example, the number of employees in the store ST, an arrangement status of the employees in the store ST, a work status of the employee in the store ST, or the like. The employee status information is not limited to this, and may include various types of information regarding the employee.

For example, in a case where the number of employees in the store ST is insufficient with respect to the number of customers, the number of employees coping with the reception of the order for the first delivery service becomes insufficient. In such a case, as in a case where the store ST is congested, it is necessary to limit the reception of the order for the first or second delivery service. In this way, the status of the employee in the store ST may affect the reception of the order for the first and second delivery services.

In FIG. 3, as an example of the sensor unit 20, a camera 21 is illustrated. The camera 21 is an imaging device that images inside of the store. The camera 21 is provided, for example, on a ceiling or a wall of the store ST, and images the inside of the store ST from a predetermined direction. The plurality of cameras 21 may be provided in the store ST. The camera 21 may be provided, for example, at each of a selling space where products are displayed, a checkout area where a settlement device for checking out the product is provided, or a position where the camera 21 can image an entrance or the like of the store ST.

The camera 21 performs imaging in each region in the store ST and outputs an imaged image obtained by imaging to the store terminal 30. The camera 21 may output the imaged image to the store terminal 30 at predetermined time intervals. The imaged image may be a moving image or a still image. In the present disclosure, “the imaged image” may mean imaged image data which is data of the imaged image.

The sensor unit 20 may include a sensor other than the camera 21. For example, the sensor unit 20 may be a store entrance sensor that detects entry of a customer, at an entrance of the store ST. By detecting the entry of the customer by the store entrance sensor, the number of customers who have entered the store ST can be detected. The store entrance sensor may be configured to be able to detect leaving of a customer. By detecting the leaving of the customer, the number of customers who have left the store ST can be detected.

In addition, for example, the sensor unit 20 may be a reading device that reads information in an integrated circuit (IC) tag provided in a shopping cart used by a customer. In this case, the reading device can detect that the shopping cart has passed through a predetermined place in the store ST.

Moreover, for example, in a case where a customer checks out a product during shopping, by using a terminal device of the store ST or a terminal device owned by the customer, the sensor unit 20 may be achieved by using the terminal device. For example, it is assumed that a predetermined checkout application for the customer to perform checkout be installed in the terminal. In this case, the sensor unit 20 receives data regarding shopping from the terminal, via the checkout application. The sensor unit 20 can detect a timing at which the customer starts shopping and a timing at which the customer ends shopping, by using the data. As a result, the stay time of the customer may be calculated.

### Store Terminal 30

The store terminal 30 is a terminal device provided in the store ST. The store terminal 30 transmits the customer status information detected by using the sensor unit 20 to the service provision device 10. In a case where the service provision device 10 has received the order for the first delivery service, the store terminal 30 receives information regarding the order from the service provision device 10. The store terminal 30 notifies the employee A of the information regarding the order.

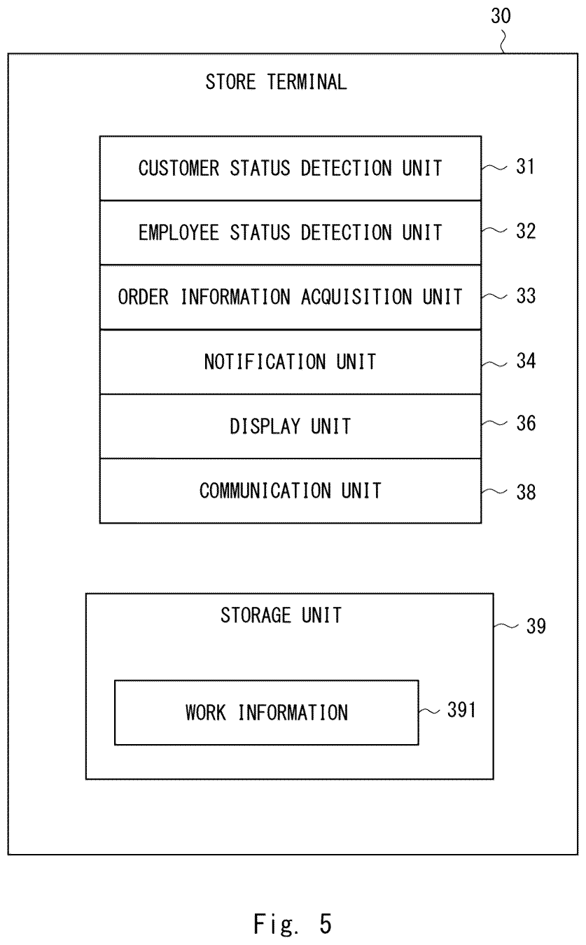

Here, the store terminal 30 will be described, with reference to FIG. 5. FIG. 5 is a block diagram illustrating a configuration of the store terminal 30. The store terminal 30 includes a customer status detection unit 31, an employee status detection unit 32, an order information acquisition unit 33, a notification unit 34, a display unit 36, a communication unit 38, and a storage unit 39.

The customer status detection unit 31 acquires the data detected by the sensor unit 20 and detects the customer status information from the data. The customer status detection unit 31 transmits the detected customer status information to the service provision device 10 via the communication unit 38.

For example, the customer status detection unit 31 acquires the image imaged by the camera 21. The customer status detection unit 31 extracts the number of customers included in the imaged image, by using a well-known image recognition technology or the like. The customer status detection unit 31 may detect the number of customers by using the store entrance sensor described above or the like.

The customer status detection unit 31 may detect the stay time of the customer, by using the reading device described above. Moreover, the customer status detection unit 31 may detect the stay time of the customer, by using the timing at which the customer starts shopping and the timing at which the customer ends shopping, via the checkout application described above. The customer status detection unit 31 detects, for example, an average stay time per customer.

In addition, the customer status detection unit 31 may detect the operation status of the settlement device in the checkout area as the customer status information. For example, the customer status detection unit 31 detects the operation status of the settlement device, from the imaged image obtained by imaging the checkout area. The present disclosure is not limited to this, and the customer status detection unit 31 may acquire information regarding checkout from the settlement device and detect the operation status of the settlement device. The information regarding the checkout is, for example, information indicating that the settlement device is operated by an operation of an employee in charge of checkout. For example, the customer status detection unit 31 detects that the employee causes the settlement device to read an employee number assigned to the employee. As a result, the customer status detection unit 31 detects that the settlement device is operating.

The settlement device may be a self-checkout machine operated by the customer. In this case, the customer status detection unit 31 detects, for example, that the customer presses a “checkout start” button displayed on a display unit of the settlement device. As a result, the customer status detection unit 31 detects that the settlement device is operating.

The customer status detection unit 31 may detect the number of customers waiting for the checkout in the store ST, by using the imaged image described above. The customer status detection unit 31 detects the number of customers standing in line and waiting for the settlement device, from the imaged image of the checkout area, by using the image recognition technology.

The employee status detection unit 32 acquires the data detected by the sensor unit 20 and detects the employee status information from the data. The employee status detection unit 32 transmits the detected employee status information to the service provision device 10 via the communication unit 38.

The employee status detection unit 32 detects the number of employees in the store ST, for example, by using the imaged image of the camera 21. The employee status detection unit 32 may detect the number of employees for each selling space. For example, the store terminal 30 registers a face image of the employee of the store ST in the storage unit 39 in advance. The employee status detection unit 32 detects the employee by comparing a face image of a person included in the imaged image with the face image of the employee registered in advance. The employee status detection unit 32 extracts the employee from the imaged image, by using a comparison result. As a result, the employee status detection unit 32 can detect the number of employees included in the imaged image.

The employee status detection unit 32 may detect the employee status information by referring to work information 391 stored in the storage unit 39 and acquiring the number of employees arranged in the store ST. For example, the work information 391 may include information regarding a shift table indicating a working schedule of the employee on the day, time card punching information indicating a work status on the day, or the like.

The order information acquisition unit 33 acquires the order information regarding the first delivery service from the service provision device 10. The order information may include, for example, an order number, order content, a delivery date and time, orderer information, or the like. The order number is identification information for identifying an order.

The order content is information indicating content ordered from an orderer. The order content may include, for example, information such as a product name, a quantity, a price, or a total amount. The delivery date and time indicates a date and time at which a product is delivered. The delivery date and time may be expressed by a delivery date and a delivery time band. The delivery date may be a current day, a next day, or later. The orderer information is information regarding an orderer. The orderer information may include, for example, a name of the orderer, a delivery destination address, a contact address, or the like. Since these are examples, the order information may include other information. The order information does not need to include a part of the information described above.

The notification unit 34 notifies the employee A of the order information acquired by the order information acquisition unit 33. For example, the notification unit 34 displays the order information on the display unit 36. In a case where each employee uses a terminal device, the notification unit 34 may display the order information on each of the terminal devices.

The display unit 36 is a display device that displays information. The display unit 36 displays the order information. The display unit 36 may be a touch panel or the like. The employee A grasps the content of the ordered product by visually recognizing the order information displayed on the display unit 36 and performs picking of the product or the like.

The communication unit 38 communicates with the service provision device 10, the orderer terminal 50, and the agent terminal 40, via the network N. The communication unit 38 may be a communication interface for performing wired or wireless communication.

The storage unit 39 is a storage device that stores a program for achieving each function of the store terminal 30. The storage unit 39 stores the work information 391 described above.

### Service Provision Device 10

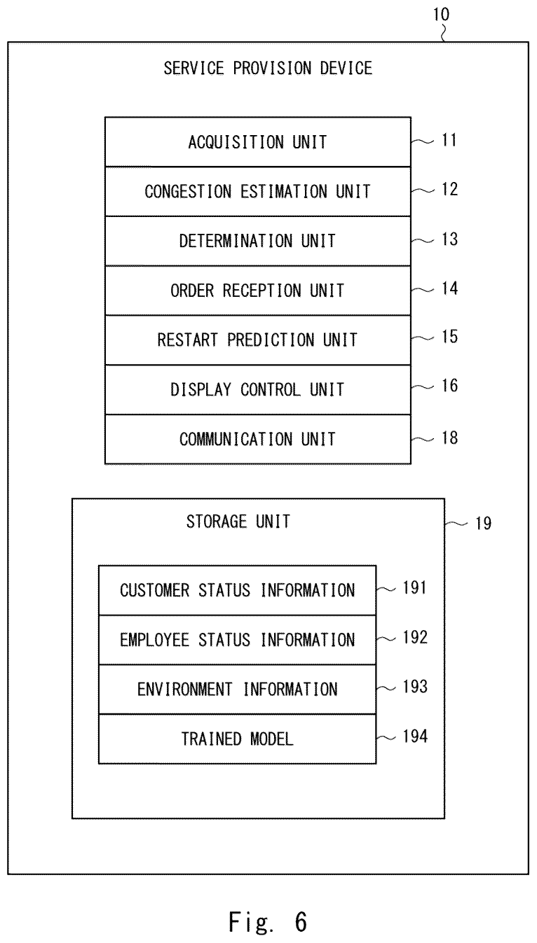

Subsequently, a configuration of the service provision device 10 will be described, with reference to FIG. 6. FIG. 6 is a block diagram illustrating the configuration of the service provision device 10. The service provision device 10 is an example of the service provision device 100 described above. The service provision device 10 manages reception of the order for the first and second delivery services having the different burdens of the employee A in the store ST. The service provision device 10 includes an acquisition unit 11, a congestion estimation unit 12, a determination unit 13, an order reception unit 14, a restart prediction unit 15, a display control unit 16, a communication unit 18, and a storage unit 19.

The acquisition unit 11 is an example of the acquisition unit 101 described above. The acquisition unit 11 acquires the customer status information indicating the status of the customer in the store ST. As described above, the customer status information may include, for example, the information regarding the number of customers in the store ST, the stay time of the customer in the store ST, the operation status of the settlement device in the store ST, the number of customers waiting for checkout in the store ST, or the like. The acquisition unit 11 receives the customer status information transmitted from the store terminal 30. The acquisition unit 11 stores the received customer status information in the storage unit 19. In FIG. 6, the stored customer status information is illustrated as customer status information 191.

In addition, the acquisition unit 11 further acquires the employee status information indicating the status of the employee in the store ST. As described above, the employee status information may include, for example, the number of employees in the store ST, the arrangement status of the employees in the store ST, the work status of the employee in the store ST, or the like. The acquisition unit 11 receives the employee status information transmitted from the store terminal 30. The acquisition unit 11 stores the received employee status information in the storage unit 19. In FIG. 6, the stored employee status information is illustrated as employee status information 192.

Moreover, the acquisition unit 11 may acquire environment information indicating an environment around the store ST. The environment information is information that may affect the congestion status in the store ST. The environment information is, for example, weather, a temperature, or the like around the store ST. The environment information may be information obtained by predicting weather or a temperature at an estimation target date and time for which a congestion status is estimated. The environment information may be information regarding a day of the estimation target date and time, an event held at a timing close to the date and time, or the like.

The acquisition unit 11 may acquire the environment information from another device, via the network N. The acquisition unit 11 acquires, for example, the information regarding the weather and the temperature according to the position of the store ST from a weather forecast service or the like. The acquisition unit 11 acquires the information regarding the event from an event information provision service or the like. The acquisition unit 11 stores the acquired environment information in the storage unit 19. In FIG. 6, the stored environment information is illustrated as environment information 193.

The acquisition unit 11 may acquire the customer status information 191, the employee status information 192, and the environment information 193 from the store terminal 30 or another device at predetermined time intervals. The acquisition unit 11 may store the past customer status information 191, the past employee status information 192, and the past environment information 193 in the storage unit 19, in association with the congestion status related to each piece of the information. As a result, the service provision device 10 can use the customer status information 191, the employee status information 192, and the environment information 193 in the past, as teacher data used to estimate the congestion status of the store ST at the estimation target date and time.

The congestion estimation unit 12 is an example of the congestion estimation unit 102 described above. The congestion estimation unit 12 estimates the congestion status of the store ST at the estimation target date and time, based on the customer status information 191. The estimation target date and time may be, for example, a predetermined time after the current time (for example, 30 minutes later, 1 hour later, or 2 hours later) or may be a predetermined future date and time. For example, the congestion estimation unit 12 estimates the congestion status of the store ST, based on at least one of the number of customers, the stay time of the customer, the operation status of the settlement device, and the number of customers waiting for checkout.

The congestion estimation unit 12 may estimate the congestion status in consideration of other pieces of information, in addition to these pieces of information. The congestion estimation unit 12 may calculate a congestion degree indicating a degree of the congestion status of the store ST, based on the customer status information 191. The congestion degree may be expressed by using a numerical value or may be expressed by using an expression such as “congested” or “not congested”.

The congestion estimation unit 12 may estimate the congestion status, further based on the environment information 193. For example, in a case where the weather around the store ST at the estimation target date and time is rain, the congestion estimation unit 12 estimates that the congestion degree at the estimation target date and time is low. For example, in a case where an event is held around the store ST at a timing close to the estimation target date and time, the congestion estimation unit 12 estimates that the congestion degree at the estimation target date and time is high.

The congestion estimation unit 12 may estimate the congestion status by using a trained model that has performed predetermined training. For example, the congestion estimation unit 12 estimates the congestion status by using a trained model 194 stored in the storage unit 19 in advance.

The trained model 194 is trained by using the past customer status information 191 and the congestion status related to the customer status information 191, as the teacher data, by a training unit (not illustrated). The training unit may train the trained model 194 by using an artificial intelligence (AI). The trained model 194 may be, for example, a neural network or a mathematical model other than the neural network.

As a result, the trained model 194 is trained to estimate the congestion status from the input customer status information and output an estimation result. The congestion estimation unit 12 inputs the customer status information in the trained model 194 and acquires the estimation result of the congestion status of the store ST from the trained model 194, as an output.

The training unit may train the trained model 194, by further using the employee status information 192 as the teacher data. The training unit may train the trained model 194, by further using the environment information 193 as the teacher data. As a result, the congestion estimation unit 12 estimates the congestion status of the store ST, by using at least one or more pieces of information of the customer status information 191, the employee status information 192, and the environment information 193 at the estimation target date and time and the trained model 194. The training unit may retrain the trained model 194, by using information newly acquired from the store terminal 30.

The determination unit 13 is an example of the determination unit 103 described above. The determination unit 13 determines first and second order receivable numbers indicating receivable numbers of the orders for the first and second delivery services, based on the congestion status estimated by the congestion estimation unit 12. For example, the determination unit 13 determines the first and second order receivable numbers, by adding or subtracting, according to the estimated congestion status, a number to or from the first and second reference order receivable numbers that serve as references for the first and second order receivable numbers.

The first and second reference order receivable numbers may be, for example, a maximum value of each order receivable number, in a status in which the store is not congested. The first and second reference order receivable numbers may be set in advance, by an administrator of the store ST or the like, for example. The same value or different values may be set to the first and second reference order receivable numbers.

The first and second reference order receivable numbers may be set to numbers different for each time band (for example, morning, daytime, evening, night, or the like). For example, since the congestion is expected during the day, by setting a small reference order receivable number in advance, the determination unit 13 can determine the first and second order receivable numbers according to the daytime time band.

Description will be made by using a specific numerical value. For example, it is assumed that the first reference order receivable number be 10. In a case where it is estimated that the store ST is congested, the determination unit 13 subtracts, for example, 2 from the first reference order receivable number according to the congestion status and determines the first order receivable number as 8. Conversely, in a case where it is estimated that the store ST is not congested, the determination unit 13 adds, for example, 3 to the first reference order receivable number, according to the congestion status and determines the first order receivable number as 13.

The determination unit 13 may add to the first order receivable number that was once subtracted according to the congestion status. As a result, in a case where the congestion of the store ST is resolved, the determination unit 13 can return the reduced first order receivable number to the original number. Conversely, the determination unit 13 may subtract from the first order receivable number that was once added, according to the congestion status. In this way, in a case where the store ST is congested, the increased first order receivable number can be returned to the original number.

In this way, the determination unit 13 can adjust the first order receivable number according to the congestion status of the store ST. The determination unit 13 may adjust the second order receivable number as described above, similarly to the first order receivable number.

The determination unit 13 may determine the first and second order receivable numbers by using two thresholds. For example, in a case where a congestion degree indicating the estimated congestion status is equal to or more than a first threshold, the determination unit 13 reduces the first order receivable number to a predetermined number, and in a case where the congestion degree is equal to or more than a second threshold larger than the first threshold, the determination unit 13 reduces the second order receivable number to the predetermined number. The predetermined number may be set in advance, by the administrator of the store ST or the like. The predetermined number is, for example, 0. As a result, reception of new orders by the order reception unit 14 is stopped.

For example, it is assumed that the congestion degree indicating the congestion status of the store ST be set in 10 stages of 1 to 10. The congestion degree 1 indicates a status in which the congestion degree is the smallest. The congestion degree 10 indicates a status in which the congestion degree is the largest. The first and second thresholds are set from among the congestion degrees 1 to 10.

For example, it is assumed that the first threshold be set to 7, the second threshold be set to 9, and the predetermined number be set to 0. In addition, at a certain time point, it is assumed that the congestion degree of the store ST be 5, the first order receivable number be 10, and the second order receivable number be 20. It is assumed that the number of customers in the store ST increase and the congestion estimation unit 12 estimate that the congestion degree of the store ST as 7, at a timing after a predetermined time has elapsed from the certain time point. In this case, the determination unit 13 changes the first order receivable number from 10 to 0. As a result, the order reception unit 14 stops reception of the order for the first delivery service. At this stage, since the second order receivable number remains 20, the order reception unit 14 does not stop the reception of the order for the second delivery service.

Thereafter, it is assumed that the number of customers further increase and the congestion estimation unit 12 estimate that the congestion degree of the store ST is 9. In this case, the determination unit 13 changes the second order receivable number from 20 to 0. As a result, the order reception unit 14 stops the reception of the order for the second delivery service.

The determination unit 13 may determine the first and second order receivable numbers, based on the employee status information 192, in addition to the estimated congestion status. For example, the determination unit 13 determines the first and second order receivable numbers, based on the number of employees in the store ST, the arrangement status of the employees in the store ST, the work status of the employee in the store ST, or the like. For example, the determination unit 13 adds to or subtracts from the first and second order receivable numbers, according to the number of employees arranged in the store ST. In this way, for example, the determination unit 13 can perform adjustment for determining the order receivable number at night, in a case where the number of employees is smaller than that during the day, so as to be smaller.

In a case where there is a plurality of delivery persons who delivers the first delivery service, the determination unit 13 may set the first order receivable number to each delivery person. Similarly, in a case where there is a plurality of agents who serves as an agent of the second delivery service, the determination unit 13 may set the second order receivable number to each agent. As a result, for example, even in a case where the first order receivable number of some delivery persons becomes 0, the other delivery persons can perform delivery, and accordingly, the order reception unit 14 can continue to receive the order for the first delivery service.

In a case where the order for the first or the second delivery service is received by the order reception unit 14, the determination unit 13 may subtract the number of the order from the first and second order receivable numbers and update the first and second order receivable numbers.

The order reception unit 14 is an example of the order reception unit 104 described above. The order reception unit 14 receives the orders for the first and second delivery services, based on the first and second order receivable numbers determined by the determination unit 13. In a case where one of the first and second order receivable numbers is 0, the order reception unit 14 stops reception of the order for the delivery service related to the order receivable number that has become 0. The order reception unit 14 continues to receive the order for the other delivery service. For example, in a case where the first order receivable number is 0, the order reception unit 14 stops only the reception of the first delivery service and continues the reception of the second delivery service.

The order reception unit 14 transmits order information regarding the received order, to the store terminal 30 and the agent terminal 40, via the communication unit 18. Specifically, the order reception unit 14 transmits the order information regarding the first delivery service to the store terminal 30. The order reception unit 14 transmits the order information regarding the second delivery service to the agent terminal 40.

In a case where the reception of the order for at least one of the first and second delivery services is stopped, the restart prediction unit 15 predicts a reception restart timing at which the stopped reception of the order is restarted, based on the customer status information. The restart prediction unit 15 may predict the reception restart timing, for each of the first and second delivery services.

For example, the restart prediction unit 15 refers to the customer status information 191 and acquires the customer status information acquired within a predetermined time (for example, 5 minutes) from a predicted time point. The restart prediction unit 15 predicts a timing at which the congestion of the store ST is resolved, based on the acquired customer status information. The timing may be a predetermined time (for example, 21:00 on the same day or the like) or may be a timing after a lapse of predetermined time from the predicted time point (for example, 1 hour after the predicted time point or the like).

Similarly to the customer status information, the restart prediction unit 15 may predict the reception restart timing, further based on the employee status information. Similarly, the restart prediction unit 15 may predict the reception restart timing, further based on the environment information. Specifically, the restart prediction unit 15 may acquire information used for prediction, by referring to the employee status information 192 and the environment information 193. The restart prediction unit 15 may predict the reception restart timing, by using the trained model 194.

The restart prediction unit 15 may display the predicted reception restart timing on the display unit 51 of the orderer terminal 50 of the service provision system 1. The restart prediction unit 15 displays, for example, a message such as “The first delivery service is stopped due to the congestion of the store. Reception of orders is scheduled to restart around 21:00”, on a predetermined web page for receiving orders. As a result, the orderer can grasp the reception restart timing. The restart prediction unit 15 may notify the orderer of the reception restart timing, for example, by using a method other than the display.

The display control unit 16 displays the first or second delivery service on a display screen of the display unit 51 of the orderer terminal 50. For example, the display control unit 16 displays a delivery service selection screen that receives selection of a delivery service used by an orderer, among the first and second delivery services and a store selection screen that receives selection of a store used by the orderer, from among a plurality of stores for providing the first and second delivery services, on the display unit 51.

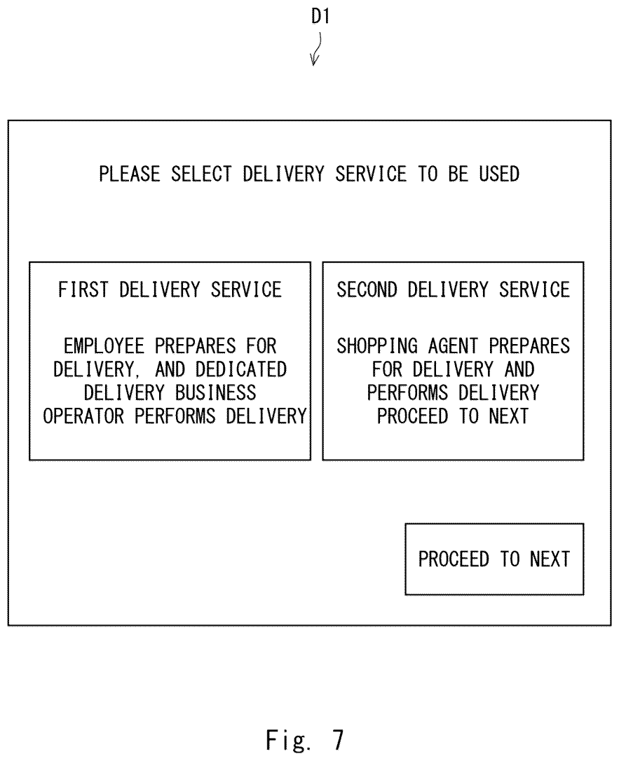

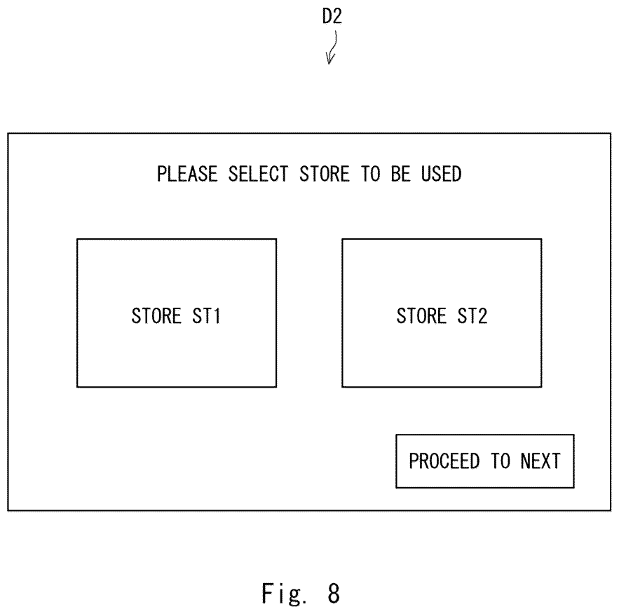

FIGS. 7 and 8 are diagrams illustrating an example of the display screen displayed by the display control unit 16. FIG. 7 is a delivery service selection screen D1 that receives the selection of the delivery service used by the orderer, among the first and second delivery services. FIG. 8 is a store selection screen D2 that receives the selection of the store used by the orderer, from among the plurality of stores for providing the first and second delivery services.

The orderer access a page on which the delivery service selection screen D1 or the store selection screen D2 is displayed, by using the orderer terminal 50. For example, the orderer first accesses the page on which the delivery service selection screen D1 is displayed and selects the first or second delivery service. Next, the orderer accesses the page on which the store selection screen D2 is displayed and selects a store to be used. Conversely, the orderer may first access the page on which the store selection screen D2 is displayed and select the store to be used. Next, the orderer accesses the page on which the delivery service selection screen D1 is displayed and selects the first or second delivery service.

By displaying such a display screen, the orderer can select the delivery service and the store. As a result, for example, the orderer can select the delivery service and the store, according to a point service provided by the store ST or the delivery business operator.

The display control unit 16 may display a screen for causing the orderer to select whether to designate the delivery service or the store, before the delivery service selection screen D1 and the store selection screen D2 are displayed. In a case where there is the plurality of delivery persons who performs delivery of the first delivery service, the display control unit 16 may display a screen that receives selection of the delivery person used by the orderer, from among the plurality of delivery persons. Similarly, in a case where there is a plurality of agents who serves as the agent of the second delivery service, the display control unit 16 may display a screen that receives selection of the agent used by the orderer, from among the plurality of agents.

The communication unit 18 communicates with the store terminal 30, the orderer terminal 50, and the agent terminal 40, via the network N. The communication unit 18 may be a communication interface for performing wired or wireless communication.

The storage unit 19 is a storage device that stores a program for achieving each function of the service provision device 10. The storage unit 19 stores the customer status information 191, the employee status information 192, the environment information 193, and the trained model 194 described above.

The configuration included in the service provision system 1 has been described above. The configuration of the service provision system 1 described above is merely an example and may be appropriately changed. For example, in a case where some or all of the components of the service provision device 10, the store terminal 30, the agent terminal 40, and the orderer terminal 50 are achieved by a plurality of service provision devices, circuits, or the like, the plurality of service provision devices, circuits, or the like may be arranged in a centralized manner or a distributed manner. For example, the service provision devices, the circuits, and the like may be achieved as a form in which each is connected via the communication network, such as a client-server system or a cloud computing system. For example, the function of the service provision device 10 may be provided in a software as a service (SaaS) format.

For example, in the above description, although the configuration has been used in which the service provision device 10 stores the customer status information 191, the employee status information 192, the environment information 193, and the trained model 194 in the storage unit 19, these may be stored in a device other than the service provision device 10. For example, the training unit that trains the trained model 194 may be included in a device other than the service provision device 10.

### Processing of Service Provision Device 10

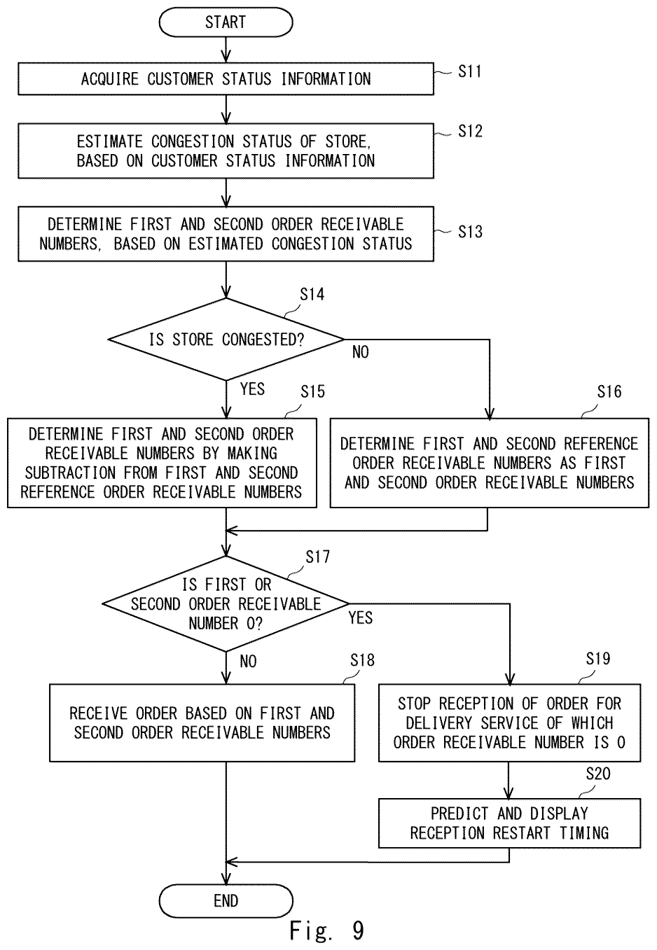

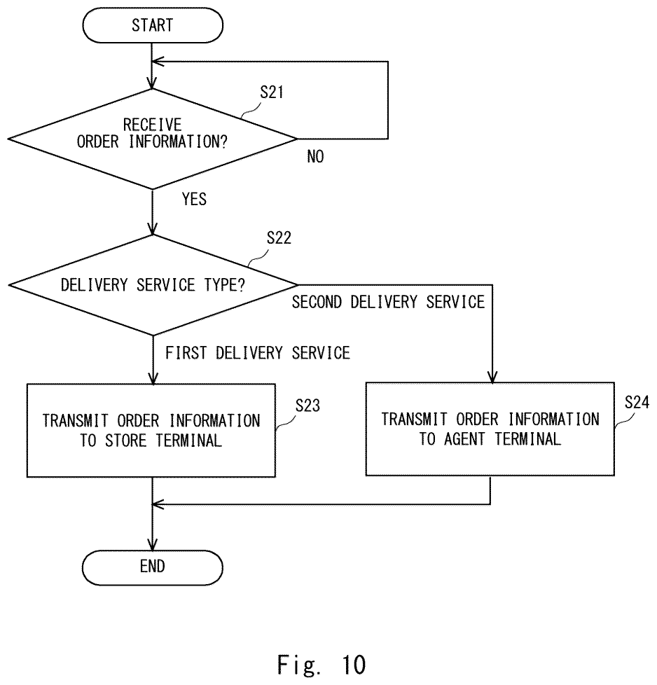

Subsequently, processing executed by the service provision device 10 will be described, with reference to FIGS. 9 and 10. FIG. 9 is a flowchart illustrating a flow of processing until the service provision device 10 receives an order. FIG. 10 is a flowchart illustrating a flow of processing after the service provision device 10 has received the order.

First, the processing until the service provision device 10 receives the order will be described, with reference to FIG. 9. In the store ST, it is assumed that the store terminal 30 detect the customer status information and the employee status information by using the data detected by the sensor unit 20 and transmit these pieces of information to the service provision device 10. The store terminal 30 detects the customer status information and the employee status information at predetermined time intervals and transmits the detection result to the service provision device 10 at the predetermined time intervals. The service provision device 10 stores the information received from the store terminal 30 in the storage unit 19, as the customer status information 191 and the employee status information 192. The service provision device 10 acquires the environment information from the weather forecast service or the like, at any timing and stores the environment information in the storage unit 19 as the environment information 193.

First, the acquisition unit 11 acquires the customer status information (S11). For example, the acquisition unit 11 refers to the customer status information 191 and acquires information within a predetermined period from the estimation target date and time. The estimation target date and time indicates a timing at which the congestion status of the store ST is estimated. The customer status information may be for example, the information regarding the number of customers in the store ST, the stay time of the customer in the store ST, the operation status of the settlement device in the store ST, the number of customers waiting for checkout in the store ST, or the like.

Next, the congestion estimation unit 12 estimates the congestion status of the store ST, based on the customer status information (S12). The congestion estimation unit 12 may estimate the congestion status by using the trained model 194 trained in advance. The congestion estimation unit 12 may estimate the congestion status, further based on the environment information 193. The environment information 193 is, for example, the weather, the temperature, the event information, or the like around the store ST.

Subsequently, the determination unit 13 determines each of the first and second order receivable numbers, based on the congestion status (S13). The first and second order receivable numbers are respectively the order receivable numbers for the first and second delivery services. For example, the determination unit 13 determines the first and second order receivable numbers by adding or subtracting, according to the congestion status, a number to or from the first and second reference order receivable numbers that serve as bases for the first and second order receivable numbers.

Specifically, first, the determination unit 13 determines whether the store ST is congested, based on the congestion status estimated by the congestion estimation unit 12 (S14). In a case of determining that the store ST is congested (YES in S14), the determination unit 13, for example, subtracts the number according to the congestion status, from the first and second reference order receivable numbers and determines each of the first and second order receivable numbers (S15). In a case of determining that the store ST is not congested (NO in S14), the determination unit 13, for example, determines the first and second reference order receivable numbers respectively as the first and second order receivable numbers (S16).

The determination unit 13 may refer to the employee status information 192 and determine each of the first and second order receivable numbers, further based on the arrangement status, the work status, or the like of the employees.

The determination unit 13 may determine the first and second order receivable numbers, by using the congestion degree indicating the congestion status.

For example, in a case where the congestion degree is equal to or more than the first threshold, the determination unit 13 reduces the first order receivable number to the predetermined number. In a case where the congestion degree is equal to or more than the second threshold, the determination unit 13 reduces the second order receivable number to the predetermined number. The second threshold is larger than the first threshold. The predetermined number is, for example, 0.

Subsequently, the order reception unit 14 determines whether the first or second order receivable number determined by the determination unit 13 is 0 (S17). In a case of determining that both of the first and second order receivable numbers are not 0 (NO in S17), the order reception unit 14 receives the order based on the first and second order receivable numbers (S18). The order reception unit 14 starts to receive the order in a case where the reception of the order is not started and continues to receive the order in a case where the reception of the order has been already started.

Although not illustrated, the orderer accesses a predetermined product page, selects a product, and orders the product, via the store terminal 30. The display control unit 16 may display the delivery service selection screen D1 and the store selection screen D2 illustrated in FIGS. 7 and 8, on the orderer terminal 50. In response to the completion of the order, the orderer terminal 50 transmits the order information of the product to the service provision device 10.

In a case of determining that one of the first and second order receivable numbers is 0 (YES in S17), the order reception unit 14 stops the order reception of the delivery service of which the order receivable number is 0 (S19). The restart prediction unit 15 refers to the customer status information 191, the employee status information 192, and the environment information 193, predicts the reception restart timing at which the stopped order reception is restarted, and displays the reception restart timing on the display unit 51 of the orderer terminal 50 (S20).

Subsequently, processing executed by the service provision device 10 after receiving the order will be described, with reference to FIG. 10. First, the order reception unit 14 determines whether the order information is received from the orderer terminal 50 (S21). In a case where the order information is not received (NO in S21), the order reception unit 14 repeats the processing in step S21. In a case where the order information is received (YES in S21), the order reception unit 14 determines whether a type of the ordered delivery service is the first delivery service or the second delivery service (S22).

In a case where the delivery service type is the first delivery service (first delivery service in S22), the order reception unit 14 transmits the order information to the store terminal 30 (S23). The order information may include, for example, the order number, the order content, the delivery date and time, the orderer information, or the like. The store terminal 30 displays, for example, the order information on the display unit 36. As a result, the employee A of the store ST can visually recognize the order information and perform the work for picking, checking out, and packing the product. The employee A passes the product to the delivery person B, and the delivery person B delivers the product.

In a case where the delivery service type is the second delivery service (second delivery service in S22), the order reception unit 14 transmits the order information to the agent terminal 40 (S24). The agent terminal 40 displays the order information on the display unit 41. As a result, the agent C can visually recognize the order information and perform the work for picking, checking out, packing, and delivering the product.

As described above, the service provision system 1 according to the present example embodiment manages the reception of the order for the first and second delivery services having the different burdens of the employee in the store. In the service provision system 1, the service provision device 10 acquires the customer status information indicating the status of the customer in the store and estimates the congestion status of the store, based on the customer status information.

Then, the service provision device 10 determines each of the first and second order receivable numbers indicating the receivable numbers of the orders for the first and second delivery services, based on the congestion status. The service provision device 10 receives the order for each of the first and second delivery services, based on the determined first and second order receivable numbers.

In this way, the service provision device 10 can manage each of the order receivable numbers for the first and second delivery services. As a result, even in a case where one of the order receivable numbers is 0, the reception of the another order can be continued. Therefore, for example, even in a case where the store is congested and the number of employees coping with the first delivery service is insufficient, the service provision device 10 stops only the reception of the order for the first delivery service and can continue to receive the order for the second delivery service.

With such a configuration, the service provision device 10 can appropriately manage the reception of the orders for the plurality of delivery services having the different burdens of the employee in the store. As a result, the service provision device 10 can reduce a possibility of losing a sales opportunity to sell products.

### Hardware Configuration Example

Each functional configuration unit of the service provision devices 10 and 100, the store terminal 30, the agent terminal 40, and the orderer terminal 50 (hereinafter, referred to as a “service provision device 10 or the like”) may be achieved by hardware (for example, a hard-wired electronic circuit or the like) that achieves each functional component, or may be achieved by a combination of hardware and software (for example, a combination of an electronic circuit and a program that controls the electronic circuit, or the like). Hereinafter, a case where each functional component of the service provision device 10 or the like is achieved by the combination of the hardware and the software will be further described.

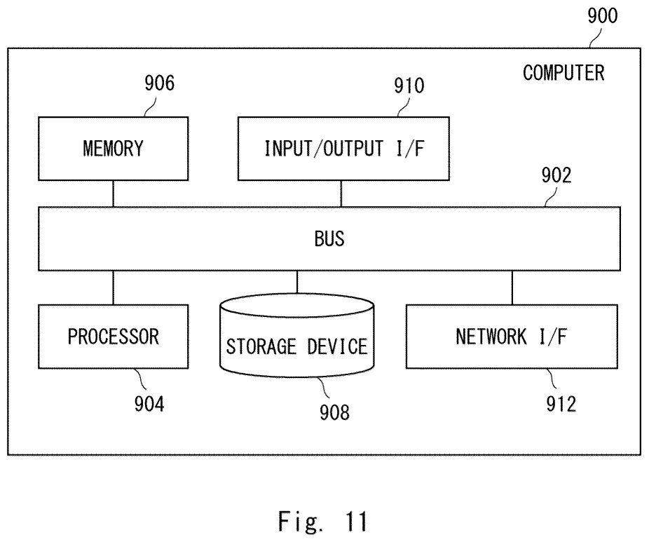

FIG. 11 is a block diagram illustrating a hardware configuration of a computer 900 that achieves the service provision device 10 or the like. The computer 900 may be a dedicated computer designed to achieve the service provision device 10 or the like or may be a general-purpose computer. The computer 900 may be a portable computer such as a smartphone or a tablet terminal.

For example, by installing a predetermined application to the computer 900, the computer 900 achieves each function of the service provision device 10 or the like. The application includes a program for achieving the functional components of the service provision device 10 or the like.

The computer 900 includes a bus 902, a processor 904, a memory 906, a storage device 908, an input/output interface 910, and a network interface 912. The bus 902 is a data transmission path for the processor 904, the memory 906, the storage device 908, the input/output interface 910, and the network interface 912 to transmit and receive data to and from each other. However, a method for connecting the processor 904 and the like to each other is not limited to the bus connection.

The processor 904 is various processors such as a central processing unit (CPU), a graphics processing unit (GPU), a field-programmable gate array (FPGA), or a quantum processor (a quantum computer control chip). The memory 906 is a main storage device achieved by using a random access memory (RAM) or the like. The storage device 908 is an auxiliary storage device achieved by using a hard disk, a solid state drive (SSD), a memory card, a read only memory (ROM), or the like.

The input/output interface 910 is an interface that connects the computer 900 to an input/output device. For example, an input device such as a keyboard and an output device such as a display device are connected with the input/output interface 910.

The network interface 912 is an interface that connects the computer 900 to a network. The network may be a local area network (LAN) or a wide area network (WAN).

The storage device 908 stores the program (the program for achieving the application) for achieving each functional component of the service provision device 10 or the like. The processor 904 loads the program onto the memory 906 and executes the program to achieve each functional component of the service provision device 10 or the like.

Each of the processors executes one or more programs including an instruction group for causing a computer to perform an algorithm that has been described with reference to the drawings. The program includes an instruction group (or software codes) for causing the computer to perform one or more functions that have been described in the example embodiments in a case where the program is read by the computer. The program may be stored in various types of non-transitory computer-readable media or tangible storage media. As an example and not by way of limitation, the non-transitory computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disk or any other optical disk storage, a magnetic cassette, a magnetic tape, a magnetic disk storage, or any other magnetic storage device. The program may also be transmitted in the various types of transitory computer-readable media or a communication medium. As an example and not by way of limitation, the transitory computer-readable medium or the communication medium includes an electric signal, an optical signal, an acoustic signal, or any other form of propagation signal.

The present disclosure is not limited to the example embodiments described above, and may be appropriately changed without departing from the scope. For example, although the service provision device 10 and the store terminal 30 are illustrated as separate devices in the service provision system 1 described above, the service provision system 1 is not limited to this. The store terminal 30 may have the function of the service provision device 10.

Some or all of the above example embodiments may also be described as the following Supplementary Notes, but are not limited to the following.

### Supplementary Note 1

A service provision device that manages reception of an order for first and second delivery services having different burdens of an employee in a store, the service provision device including:
acquisition means for acquiring customer status information indicating a status of a customer in the store;
congestion estimation means for estimating a congestion status of the store, based on the customer status information;
determination means for determining each of first and second order receivable numbers indicating order receivable numbers for the first and second delivery services, based on the congestion status; and
order reception means for receiving the order for each of the first and second delivery services, based on the first and second order receivable numbers.

### Supplementary Note 2

The service provision device according to supplementary note 1, in which the customer status information includes at least one of the number of customers in the store, a stay time of the customer in the store, an operation status of a settlement device in the store, and the number of customers waiting for checkout in the store.

### Supplementary Note 3

The service provision device according to supplementary note 1 or 2, in which the determination means determines the first and second order receivable numbers, by adding or subtracting a number according to the congestion status, to or from the first and second reference order receivable numbers that serve as references for the first and second order receivable numbers.

### Supplementary Note 4

The service provision device according to any one of supplementary notes 1 to 3, in which in a case where one of the first and second order receivable numbers is 0, the order reception means stops reception of the order for the delivery service related to the order receivable number that is 0.

### Supplementary Note 5

The service provision device according to supplementary note 4, further including restart prediction means for predicting a timing at which the stopped reception of the order is restarted, based on the customer status information, in a case where the reception of the order for at least one of the first and second delivery services is stopped.

### Supplementary Note 6

The service provision device according to any one of supplementary notes 1 to 5, in which
the first delivery service has a larger burden on the employee than the second delivery service, and
in a case where a congestion degree indicating the congestion status is equal to or more than a first threshold, the determination means reduces the first order receivable number to a predetermined number, and in a case where the congestion degree is equal to or more than a second threshold larger than the first threshold, the determination means reduces the second order receivable number to the predetermined number.

### Supplementary Note 7

The service provision device according to any one of supplementary notes 1 to 6, further including display control means for displaying a display screen on display means of an orderer terminal used to order the first or second delivery service,
in which the display control means displays a delivery service selection screen that receives selection of a delivery service used by an orderer from among the first and second delivery services and a store selection screen that receives selection of a store used by the orderer, from among a plurality of stores that provides the first and second delivery services, on the display means.

### Supplementary Note 8

The service provision device according to any one of supplementary notes 1 to 7, in which
the acquisition means further acquires employee status information indicating a status of the employee in the store, and
the determination means determines the first and second order receivable numbers, further based on the employee status information.

### Supplementary Note 9

The service provision device according to any one of supplementary notes 1 to 8, in which
the acquisition means further acquires environment information indicating an environment around the store, and
the congestion estimation means estimates the congestion status, further based on the environment information.

### Supplementary Note 10

A service provision system that manages reception of an order for first and second delivery services having different burdens of an employee in a store, the service provision system including:
a sensor configured to detect customer status information indicating a status of a customer in the store; and a service provision device,
in which the service provision device includes
acquisition means for acquiring the customer status information detected by using the sensor,
congestion estimation means for estimating a congestion status of the store, based on the customer status information,
determination means for determining each of first and second order receivable numbers indicating order receivable numbers for the first and second delivery services, based on the congestion status, and
order reception means for receiving the order for each of the first and second delivery services, based on the first and second order receivable numbers.

### Supplementary Note 11

The service provision system according to supplementary note 10, in which the customer status information includes at least one of the number of customers in the store, a stay time of the customer in the store, an operation status of a settlement device in the store, and the number of customers waiting for checkout in the store.

### Supplementary Note 12

A service provision method for managing reception of an order for first and second delivery services having different burdens of an employee in a store, the service provision method including:
acquiring customer status information indicating a status of a customer in the store;
estimating a congestion status of the store, based on the customer status information;
determining each of first and second order receivable numbers indicating order receivable numbers for the first and second delivery services, based on the congestion status; and
receiving the order for each of the first and second delivery services, based on the first and second order receivable numbers.

### Supplementary Note 13

The service provision method according to supplementary note 12, in which the customer status information includes at least one of the number of customers in the store, a stay time of the customer in the store, an operation status of a settlement device in the store, and the number of customers waiting for checkout in the store.

### Supplementary Note 14

A non-transitory computer-readable medium storing a program for causing a computer of a service provision device that manages reception of an order for first and second delivery services having different burdens of an employee in a store, in which
the program causes the computer to execute
acquisition processing for acquiring customer status information indicating a status of a customer in the store;
congestion estimation processing for estimating a congestion status of the store, based on the customer status information;
determination processing for determining each of first and second order receivable numbers indicating order receivable numbers for the first and second delivery services, based on the congestion status; and
order reception processing for receiving the order for each of the first and second delivery services, based on the first and second order receivable numbers.

### Supplementary Note 15

The non-transitory computer-readable medium according to supplementary note 14, in which the customer status information includes at least one of the number of customers in the store, a stay time of the customer in the store, an operation status of a settlement device in the store, and the number of customers waiting for checkout in the store.

### REFERENCE SIGNS LIST

1 service provision system
10 service provision device
11 acquisition unit
12 congestion estimation unit
13 determination unit
14 order reception unit
15 restart prediction unit
16 display control unit
18 communication unit
19 storage unit
20 sensor unit
21 camera
30 store terminal
31 customer status detection unit
32 employee status detection unit
33 order information acquisition unit
34 notification unit
36 display unit
38 communication unit
39 storage unit
40 agent terminal
41 display unit
50 orderer terminal
51 display unit
100 service provision device
101 acquisition unit
102 congestion estimation unit
103 determination unit
104 order reception unit
191 customer status information
192 employee status information
193 environment information
194 trained model
391 work information
900 computer
902 bus
904 processor
906 memory
908 storage device
910 input/output interface
912 network interface
A employee
B delivery person
C agent
D1 delivery service selection screen
D2 store selection screen
N network
ST store

What is claimed is:

1. A service provision device that manages reception of an order for first and second delivery services having different burdens of an employee in a store, the service provision device comprising:
at least one memory storing instructions; and
at least one processor configured to execute the instructions to:
acquire customer status information indicating a status of a customer in the store;
estimate a congestion status of the store, based on the customer status information;
determine each of first and second order receivable numbers indicating order receivable numbers for the first and second delivery services, based on the congestion status; and
receive the order for each of the first and second delivery services, based on the first and second order receivable numbers.

2. The service provision device according to claim 1, wherein the customer status information includes at least one of the number of customers in the store, a stay time of the customer in the store, an operation status of a settlement device in the store, and the number of customers waiting for checkout in the store.

3. The service provision device according to claim 1, wherein the at least one processor is further configured to execute the instructions to determine the first and second order receivable numbers, by adding or subtracting a number according to the congestion status, to or from the first and second reference order receivable numbers that serve as references for the first and second order receivable numbers.

4. The service provision device according to claim 1, wherein in a case where one of the first and second order receivable numbers is 0, the at least one processor is further configured to execute the instructions to stop reception of the order for the delivery service related to the order receivable number that is 0.

5. The service provision device according to claim 4, wherein the at least one processor is further configured to execute the instructions to predict a timing at which the stopped reception of the order is restarted, based on the customer status information, in a case where the reception of the order for at least one of the first and second delivery services is stopped.

6. The service provision device according to claim 1, wherein
the first delivery service has a larger burden on the employee than the second delivery service, and
in a case where a congestion degree indicating the congestion status is equal to or more than a first threshold, the at least one processor is further configured to execute the instructions to reduce the the first order receivable number to a predetermined number, and in a case where the congestion degree is equal to or more than a second threshold larger than the first threshold, to reduce the second order receivable number to the predetermined number.

7. The service provision device according to claim 1, wherein the at least one processor is further configured to execute the instructions to:
display a display screen on a display unit of an orderer terminal used to order the first or second delivery service; and
display a delivery service selection screen that receives selection of a delivery service used by an orderer from among the first and second delivery services and a store selection screen that receives selection of a store used by the orderer, from among a plurality of stores that provides the first and second delivery services, on the display unit.

8. The service provision device according to claim 1, wherein the at least one processor is further configured to execute the instructions to:
acquire employee status information indicating a status of the employee in the store; and
determine the first and second order receivable numbers, further based on the employee status information.

9. The service provision device according to claim 1, wherein the at least one processor is further configured to execute the instructions to:
acquire environment information indicating an environment around the store; and
estimate congestion status, further based on the environment information.

10.-11. (canceled)

12. A service provision method for managing reception of an order for first and second delivery services having different burdens of an employee in a store, the service provision method comprising:
acquiring customer status information indicating a status of a customer in the store;
estimating a congestion status of the store, based on the customer status information;
determining each of first and second order receivable numbers indicating order receivable numbers for the first and second delivery services, based on the congestion status; and
receiving the order for each of the first and second delivery services, based on the first and second order receivable numbers.

13. The service provision method according to claim 12, wherein the customer status information includes at least one of the number of customers in the store, a stay time of the customer in the store, an operation status of a settlement device in the store, and the number of customers waiting for checkout in the store.

14. A non-transitory computer-readable medium storing a program for causing a computer of a service provision device that manages reception of an order for first and second delivery services having different burdens of an employee in a store, wherein
the program causes the computer to execute
acquisition processing for acquiring customer status information indicating a status of a customer in the store;
congestion estimation processing for estimating a congestion status of the store, based on the customer status information;
determination processing for determining each of first and second order receivable numbers indicating order receivable numbers for the first and second delivery services, based on the congestion status; and
order reception processing for receiving the order for each of the first and second delivery services, based on the first and second order receivable numbers.

15. The non-transitory computer-readable medium according to claim 14, wherein the customer status information includes at least one of the number of customers in the store, a stay time of the customer in the store, an operation status of a settlement device in the store, and the number of customers waiting for checkout in the store.
